(19) United States
(12) Patent Application Publication
(10) Pub. No.: US 2006/0096432 A1
(43) Pub. Date: May 11, 2006

(54) Device for feeding organic plant material into the cutting zone of a cutting machine particularly for tobacco

(76) Inventors: Jerzy W. Chojnacki, Radom (PL); Roman Kaczor, Sienno (PL)

Correspondence Address: DARBY & DARBY P.C., P. O. BOX 5257, NEW YORK, NY, 10150-5257, US

(21) Appl. No.: 10/524,938

(22) PCT Filed: Nov. 27, 2002
(86) PCT No.: PCT/PL02/00099

§ 371 Date: Oct. 17, 2005

(30) Foreign Application Priority Data
Sep. 12, 2002 (PL) P.356019

(51) Int. Cl. B26D 7/06

(52) U.S. Cl. 83/401

(57) ABSTRACT

The invention relates to a device for feeding a material into a cutting/comminution zone of a cutting machine for plant materials, particularly for tobacco, comprising a transporting device which transports wetted tobacco material into the cutting/comminution zone and comprises at least one transmission belt equipped with at least one endless transmission belt. The transporting device (5) is joined with self-supporting bearing structure preferably defining guides (7). The working surface of the transmission belt (14) of the main conveyor (5a) is positioned at an angle beta (β) between 10° and +10° relatively to the horizontal direction, an access space (P) being formed between the transporting device (5) and the immobile body (1) of the cutting machine cutterhead (2) when in a service position.

The present invention relates to a device for feeding organic plant material into the cutting zone of a cutting machine particularly for tobacco.

The solution relates to a device for cutting/comminution organic materials, mainly plant materials, particularly tobacco materials.

Feed material for the cutting machine is tobacco in any of various forms, e.g., including leaves or parts thereof, veins of tobacco leaves, tobacco foils, cigar fillings, chopped filling of cigarettes, trimmings and/or crumbs, and any combination of tobacco comprising materials, in any form. It is suggested to process the tobacco material prior to feeding it to the cutting machine so that moisture content in the fed material is uniform for the whole portion, at the level of at least 13-14%. by weight, suitably at least 16% by weight, preferably more than 19% by weight. Details of the above mentioned processes for increasing humidity are known and used in the art.

Wetted tobacco is fed to the feeding device/conveyor of the cutting machine by means of any known technique, most commonly a conventional method. An exemplary process for tobacco processing may be carried out according to patent application U.S. Pat. No. 5,722,431.

Devices/arrangements forming a stream of a fed material constitute a part of a cutting/comminution process in which feeding of the material into a cutting/comminution zone in a manner guaranteeing uniformity and homogeneity of the feed, meeting as well additional requirements known to those skilled in the art of tobacco processing, is a condition for an accurate cutting/comminution process.

The cutting machine operation results in tobacco (product); for instance cut tobacco, cut and/or comminuted tobacco, according to requirements and technological parameters.

In known solutions, a tobacco feeding-forming arrangement is statically attached to a body of a machine in which a rotary cutter drum is placed.

There is only limited access to the cutterhead and parts thereof in known cutting machines.

Known devices for feeding the material to the cutting/comminution zone of cutting machine for plant materials, particularly for tobacco, comprise a transporting device that transports the wetted tobacco to the cutting/comminution zone and comprises at least one conveyor usually equipped with a transmission belt(s). The transmission belts are made of non-ferrous metal alloys. The device according to the invention is characterised in that the transporting device is joined with a self-supporting bearing structure preferably defined in guides. The working surface of the transmission belt of the main conveyor is situated relative to the horizontal direction at an angle beta between −10° and +10°, an access space being formed between the transporting device and the immobile body of the cutting machine cutterhead when in a service position.

The transporting device has an upper conveyor situated over the main conveyor.

Preferably, the upper conveyor is a vibrating plate.

The main conveyor and the upper conveyors are equipped with endless transmission belts.

Preferably, the transmission belts are of a module structure.

The transmission belts are made from a material other than non-ferrous metals.

Positions of the front roll and the rear roll are independently adjusted within predetermined ranges, preferably at least along the vertical axis from zero to a predetermined maximum value.

Preferably, the main conveyor and the upper conveyor are situated relative each to other with controlled relative convergence defined by an angle alpha towards the outlet of the transported material.

Preferably, vibration portions are placed under the upper surface of the transmission belt of the main conveyor, which allow the upper surface to be brought into vibrating movement with such oscillation parameters which advantageously affect polarisation and compacting of particles of the transported material.

Preferably, the angle of beta is in the range from 0° to 5°.

Furthermore, inclination of the angle of beta is along the direction of transport, towards the outlet.

The guides are placed at a height equal at least to the height of the upper conveyor.

Preferably, the upper conveyor is a vibrating plate moved independently and/or with the main conveyor. According to the invention, the upper conveyor may be completely removed or replaced, by a suitably shaped plate only, which may be moved independently and/or with the lower conveyor or an arrangement of conveyors and which may be brought into controlled vibrating movement with such oscillation parameters which advantageously affect polarization and compacting of particles of the transported material.

Preferably, the drive of the main conveyor is placed on the rear roll.

Preferably, the drive of the main conveyor is placed on the front roll.

Preferably, the drive of the upper conveyor is placed on the rear roll.

Preferably, the drive of the upper conveyor is placed on the front roll.

The transporting device is joined with the lower knife of the mouthpiece, an edge of which is situated in a working position, at a near to zero distance from a surface of a cylinder defined by the edges of the knives of the cutterhead.

Moreover, a conveyor is placed between the self-supporting bearing structure and the floor, the conveyor receiving cut material from the cutting/comminution zone.

An advantage of the presented solution is that the transporting device/arrangement feeding the wetted tobacco into the cutting/comminution zone is not permanently attached to the cutterhead body.

The structure of the material feeding arrangement according to the invention makes it possible to displace the arrangement of the conveyors together with the self-supporting bearing structure, preferably on the guides placed at a height equal to or higher than the upper conveyor, from a servicing position to a working position prior to the cutting/comminution process, and to retract it again into the servicing position after completing or interrupting the process, according to requirements of the technological process.

The solution according to the invention allows for optimal, full, safe and direct access from the floor/base level to all operational zones and modules of the cutting machine, which affect the way and quality of operation of the device, particularly a directly and easily accessible maintenance-servicing space formed after removing a moveable body comprising conveyor(s), feeding and/or forming a stream of tobacco, from the stationary body, comprising the cutterhead, to the cutting/comminution zone. By means of this feature significant facilitation, improvement and rationalization of all, periodically carried out operations for proper, failure-free operation of the cutting machine are achieved.

The applied relative convergence of the both conveyors, described by the angle alpha is known in the art; however, applying of the inclination of the lower conveyor transmission belt towards the outlet is a significant innovation and advantage in respect of servicing of the machine, whereas advantageously affecting the result of the transporting, compacting and cutting/comminution process of the plant material, particularly tobacco material.

An advantage of the solution is that the drive of the lower conveyor may be transferred from the front roll to the rear roll such that the upper surface of the transmission belt is compressed by a driving force, instead of being stretched as in known solutions. A similar solution relates to the upper conveyor, in which the drive may be placed on the front roll or, optionally, on the rear roll.

The structure of the arrangement of the conveyors guarantees that along the whole path of the transport the transported material has no contact with parts made of or covered with non-ferrous metals and/or alloys thereof.

As a result of applied innovations, the machine achieves better effects of cutting/comminution of the material and allows for significant simplification of service and operation handling of the machine.

An embodiment of the invention will be described in reference to the accompanying drawings, in which:

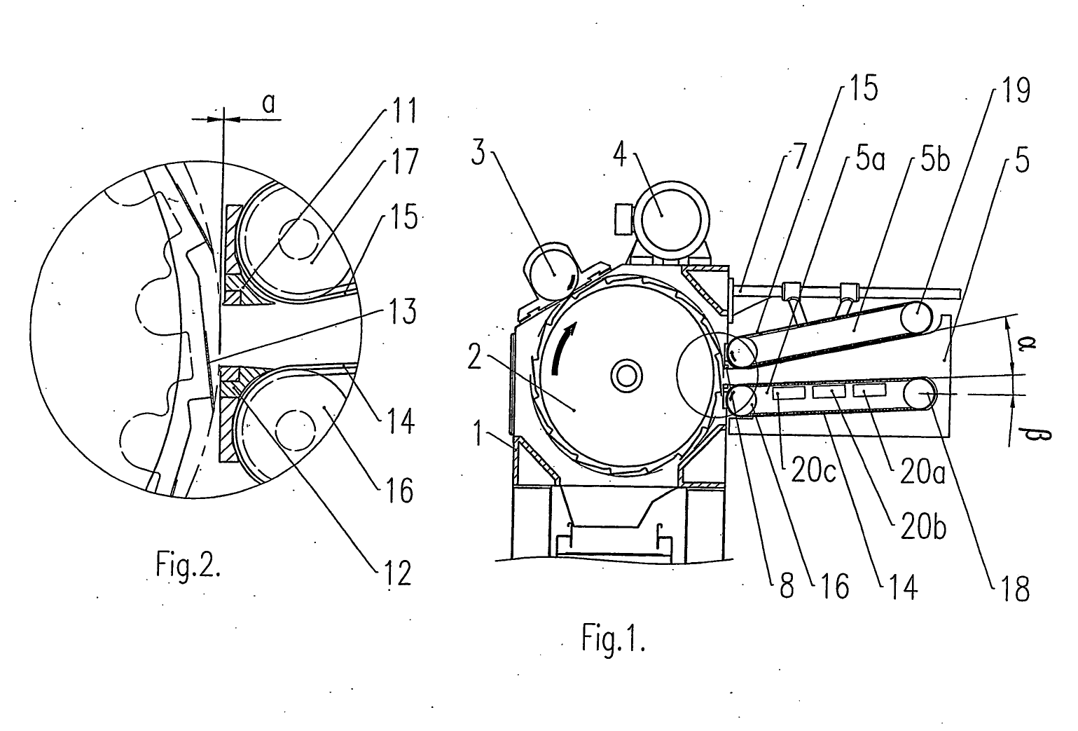

FIG. 1 is a simplified side view illustrating the cutting machine after removing guarding elements, with the device according to the invention shown,

FIG. 2 presents an enlarged, marked detail of FIG. 1,

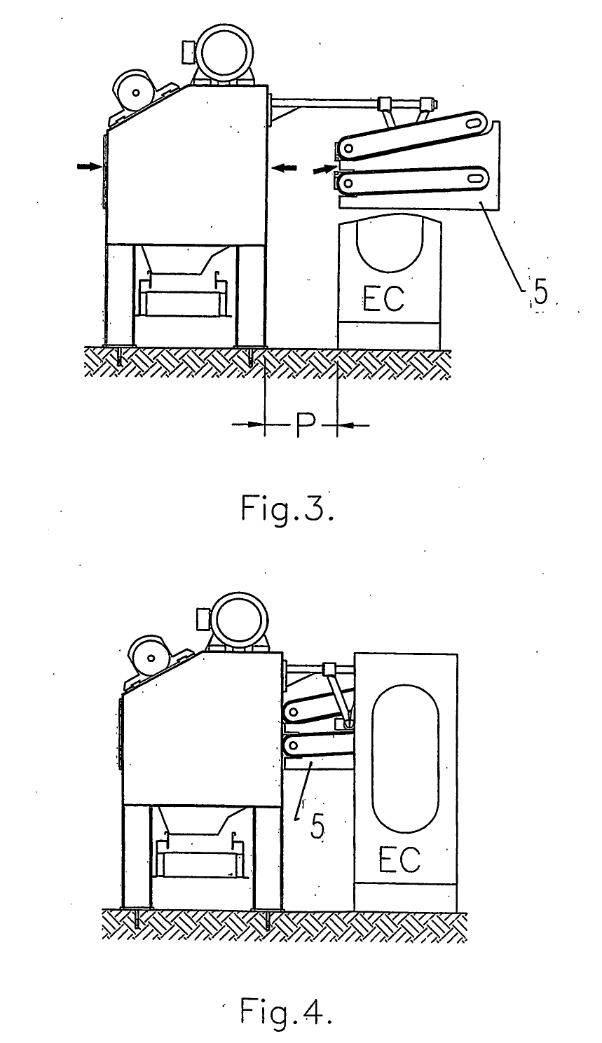

FIG. 3 is a simplified side view of the cutting machine with the access space shown,

FIG. 4 is a simplified side view of the cutting machine with the transporting device being moved adjacent to the main body.

In the proposed solution shown in FIG. 1, the device consists of the transporting device 5, which feeds wetted tobacco material into the cutting/comminution zone; the device together with its integral body is not permanently affixed to the body 1 of the cutterhead 2. The transporting device 5 is preferably equipped with the upper conveyor 5b situated over the main conveyor 5a.

Both the main conveyor 5a and the upper conveyor 5b have transmission belts.

The primary task of the main conveyor 5a and the upper conveyor 5b is to advantageously form and feed a stream of the material to a close proximity and/or into the cutting/comminution zone, as shown in FIG. 2.

Both the main conveyor 5a and the upper conveyor 5b are positioned with an adjusted relative convergence, defined by the angle alpha α towards the outlet of the fed material, the working (upper) surface of the transmission belt of the main conveyor 5a is positioned at an angle beta (β) of −10° to +10° relative to the horizontal direction, preferably from 0° to 5°, and preferably towards the direction of transport, i.e., towards the outlet, the conveyors having endless transmission belts 14, 15 for transporting the material to a close proximity and/or directly into the cutting/comminution zone, the transmission belts having direct contact with the transported material and being made from materials other than conventionally used metal alloys, such as bronze/brass. In order to make proper operation and/or maintenance possible, the structure of the feeding arrangement makes it possible to displace the arrangement of the conveyors prior to the cutting/comminution process together with the self-supporting bearing structure, preferably on the guides 7, see FIG. 1, placed at a height equal to or higher than the upper conveyor 5b, from a servicing position, see FIG. 3, to a working position, see FIG. 4, and to retract it again into the servicing position after completing or interrupting the process, according to requirements of the technological process.

As shown in FIG. 3, in the servicing position an access space P is created between the transporting device 5 and the immobile body 1 of the cutterhead 2 of the cutting machine.

Both the main conveyor 5a and the upper conveyor 5b are equipped with endless transmission belts of a modular structure.

Positions of the front roll 17 and the rear roll 19 of the upper conveyor 5b are independently adjusted within predetermined ranges, preferably at least along the vertical axis, from zero to a pre-determined maximum value.

Vibrating portions 20a, 20b, 20c are provided below the upper surface of the transmission belt 14 of the main conveyor 5a (details of this solution have been given in preceding application No P 353387 of Apr. 12, 2002), the vibrating portions making it possible to bring the upper surface of the transmission belt with the material into a vibrating movement with such oscillation parameters which advantageously affect polarization and compacting of particles of the transported material.

In an embodiment not shown in the drawing the upper conveyor 5b may be completely removed or replaced by a suitably shaped plate only, which may be moved independently and/or together with the main conveyor 5a or the arrangement of conveyors and which may be brought into controlled vibrating movement with oscillation parameters which advantageously affect polarization and compacting of particles of the transported material.

According to embodiments of the invention, the drive of the main conveyor 5a may be moved from the front roll 16 to the rear roll 18, such that the upper surface of the transmission belt 14 is compressed by a driving force instead of being stretched, as in known solutions. A similar solution relates to the upper conveyor 5b, in which the drive may optionally be placed on the front roll 17 or on the rear roll 19, see FIG. 1.

The design of the suspension/supporting frame of the transporting device 5 permits a free space P to remain between the floor and the supporting frame, the free space making it possible to install, e.g., a conveyor receiving the cut material from the cutting/comminution zone.

Moreover, the structure of the transporting zone 5 ensures that the transported material has no contact with parts made from or covered with non-ferrous metals and/or alloys thereof, along the whole path of transportation.

The transporting device 5 is not permanently attached to the body of the machine, in which the rotary cutterhead 2 is placed. Guides 7 shown in FIG. 1 are an example of the solution and are used for advantageous, proper, relative positioning of the immovable body 1 of the drum with the body of the transporting device 5. In the solution according to the invention, the transporting device 5 is connected with the lower knife 12 of the mouthpiece, the edge of which is positioned in a working position at a near to zero distance a from the surface of a cylinder, defined by edges of the knives 13 of the cutterhead 2, as shown in FIG. 2.

The transporting device 5 is moved away from the body of the cutterhead 2, for example on the guides 7 placed over the body so as to create a servicing space P, see FIG. 3, directly accessible from the level of the floor/base in order to open thereby a proper and safe access to the knives 13 (see arrows in FIG. 3) as well as to the so called lower knife 12 installed in the mouthpiece, i.e., into the cutting/comminution zone, see FIG. 2.

In the proposed solution the transporting device 5 for transporting the tobacco material into the cutting/comminution zone are endless conveyor belts. Utilization of endless conveyor belts made from a material different from non-ferrous metal alloys in this step of the tobacco processing procedure is a novel solution. Inclination of the transmission belts towards the outlet of the material is justified by improvement in maintenance access and, additionally, advantageously affects the feeding, compacting and cutting/comminution process of the plant material, particularly tobacco material.

A cutting machine with a transporting device 5, comprising an integral control system EC (electrical cabinet) is shown in FIGS. 3 and 4.

1. A device for feeding a material into a cutting/comminution zone of a cutting machine for organic plant materials, particularly for tobacco, comprising a transporting device which transports wetted tobacco material into the cutting comminution zone and comprises at least one conveyor equipped with at least one transmission belt, characterized in that the transporting device (5) is coupled with a self-supporting bearing structure defined preferably by guides (7), and the working surface of the transmission belt (14) of the main conveyor (5a) is situated at an angle beta (β) from −10° to +10° relatively to the horizontal direction, and access space (P) being formed between the transporting device (5) and an immovable body (1) of the cutterhead (2) of the cutting machine when in a servicing position.

2. A device according to claim 1 characterized in that the transporting device (5) has an upper conveyor (5b) situated over the main conveyor (5a).

3. A device according to claim 2 characterized in that the upper conveyor (5b) is a vibrating plate.

4. A device according to claim 1 characterized in that the main conveyor (5a) and the upper conveyor (5b) are equipped with endless transmission belts (14, 15).

5. A device according to claim 4 characterized in that the transmission belts (14, 15) are of modular structure.

6. A device according to claim 4 characterized in that the endless transmission belts (14, 15) are made from a material other than an alloy of non-ferrous metals.

7. A device according to claim 2 characterized in that the positions of the front roll (17) and the rear roll (19) of the upper conveyor are independently adjusted in predetermined ranges, preferably at least along the vertical axis from zero to a predetermined maximum value.

8. A device according to claim 2 characterized in that the main conveyor (5a) and the upper conveyor (5b) are situated relative each to other with controlled relative convergence defined by an angle alpha (α) towards the outlet of the transported material.

9. A device according to claim 1 characterized in that vibrating portions (20a, 20b, 20c) are placed under the upper surface of the transmission belt (14) of the main conveyor (5a).

10. A device according to claim 1 characterized in that the angle beta (β) is from 0° to 5°.

11. A device according to claim 1 characterized in that inclination of the angle beta (β) is along a direction of transportation, towards the outlet.

12. A device according to claim 1 characterized in that the guides (7) are placed at a height equal at least to the height of the upper conveyor (5b).

13. A device according to claim 2 characterized in that the upper conveyor (5b) is a vibrating plate, which is moved independently and/or together with the main conveyor (5a).

14. A device according to claim 1 characterized in that a drive of the main conveyor (5a) is placed on the rear roll (18).

15. A device according to claim 1 characterized in that a drive of the main conveyor (5a) is placed on the front roll (16).

16. A device according to claim 2 characterized in that a drive of the upper conveyor (5b) is placed on the rear roll (19).

17. A device according to claim 2 characterized in that a drive of the upper conveyor (5b) is placed on the front roll (17).

18. A device according to claim 1 characterized in that the transporting device (5) is joined with the lower knife (12) of the mouthpiece, the edge of which is positioned in a working position at a near to zero distance (a) from a surface of a cylinder defined by edges of the knives (13) of the cutterhead (2).

19. A device according to claim 1 characterized in that a conveyor receiving the cut material from the cutting/comminution zone is placed between the self-supporting load-bearing structure of the transporting device (5) and the floor.
